(19) United States
(12) Patent Application Publication
(10) Pub. No.: US 2026/0120563 A1
(43) Pub. Date: Apr. 30, 2026

(54) Method for Modeling and Traffic Flow Control of a Traffic Flow System

(71) Applicant: Beijing Institute of Technology, Beijing (CN)

(72) Inventors: Ming Qu, Beijing (CN); Wen Kang, Beijing (CN); Yuqian Tang, Beijing (CN)

(21) Appl. No.: 19/026,903

(22) Filed: Jan. 17, 2025

(30) Foreign Application Priority Data
Oct. 25, 2024 (CN) 202411500762.8

(51) Int. Cl. G08G 1/01

(52) U.S. Cl. CPC G08G 1/0145

(57) ABSTRACT

A method for modeling and controlling traffic flow in a traffic flow system is provided. The method includes establishing a mathematical model of the traffic flow system, constructing an environment simulator that transforms the boundary control problem of the system into a Markov process, and designing a control method utilizing reinforcement learning algorithms to stabilize the traffic flow system. The control method interacts with the environment simulator to train an Actor-Critic network. The optimal traffic flow controller is implemented through the output of the Actor network, thereby enabling effective control of the traffic flow.

### CROSS REFERENCE TO RELATED APPLICATIONS

The present application claims the benefit of Chinese Patent Application No. 202411500762.8 filed on Oct. 25, 2024, the contents of which are incorporated herein by reference in their entirety.

### FIELD OF THE INVENTION

The present disclosure relates to the establishment of a traffic flow system model and a control method based on a reinforcement learning algorithm.

### BACKGROUND OF THE INVENTION

In traffic flow, the driving state of vehicles is influenced by various factors, such as the speed variations of preceding vehicles, specific road conditions, and the personal behaviors of drivers. To predict traffic flow changes over a future period, the Korteweg-de Vries-Burgers (KdVB) equation model can be employed, it captures the nonlinear effects and wave characteristics inherent in traffic flow, thereby providing a more accurate description of the internal flow process.

Traditional traffic flow control methods typically rely on precise modeling of the traffic system. Based on such models, engineers can design controllers to optimize traffic flow, reduce congestion, and improve road capacity. However, uncertainties or difficult-to-quantify parameters that exist in real-world scenarios make model construction for certain problems more challenging. In contrast, reinforcement learning (RL) algorithms possess unique advantages. Through interaction with the environment, RL algorithms learn from real-world experience and gradually improve their strategies through exploration and exploitation, without the need for prior knowledge of the specific environment model. In traffic flow control scenarios, RL can be viewed as an agent that observes traffic states (such as vehicle density and speed) and selects optimal actions (e.g., adjusting traffic light durations or imposing speed limits at entry or exit points) based on the current state. The agent learns the best strategy through experience. Therefore, reinforcement learning, as a model-free approach, has significant advantages in practical problems.

In conclusion, reinforcement learning, as a method that does not rely on model knowledge, has considerable benefits in practical applications such as traffic flow control. It can adapt to complex and uncertain environments by learning the best strategies through interaction with the environment. Therefore, establishing a traffic flow model and designing a controller using reinforcement learning algorithms to stabilize the traffic flow system is necessary.

### SUMMARY OF THE INVENTION

The disclosed method relates to the establishment of a traffic flow system model and a reinforcement learning-based traffic flow control method, aimed at addressing system modeling and stabilization issues in traffic flow systems where certain aspects of the system are unknown in practical engineering applications.

The disclosed method provides a technical solution comprising the following aspects:
1: Establishment of a traffic flow control problem model based on the KdVB equation.
2: Design of a control method based on a reinforcement learning algorithm.
Step 1. Transform the traffic flow control problem model into a Markov decision process (MDP). In this step, the traffic flow control problem model based on the KdVB is formulated as an MDP. The continuous spatial and temporal domains of the model are discretized to approximate the system dynamics, which ensures the validity of applying reinforcement learning algorithms. This discretization enables the reinforcement learning framework to handle the continuous nature of the system while ensuring that the problem remains tractable and the control strategy can be learned effectively.
Step 2: Establish a simulation environment for the traffic flow control problem model to collect training data. In this step, using the discretized model from step 1, the environment is defined in terms of the state vector at a given time step, which includes both the system state and control inputs. The simulation environment is then used to collect training data by interacting with the controller, generating data at each time step to reflect the state of the system as it evolves with the control inputs applied.
Step 3: Train the Actor-Critic Network. In this step, an Actor-Critic architecture is used to train the reinforcement learning controller. The Critic network approximates the value function, which evaluates the quality of the current policy. Based on the evaluation from the Critic network, the parameters of the Critic network are updated to improve the accuracy of the value function approximation. Using the updated value function, the parameters of the Actor network are adjusted to optimize the control policy. The controller interacts with the system environment using the updated policy, collecting new data for further training. This process of updating the network parameters and refining the policy is repeated for a predefined number of iterations. Once sufficient training has been completed, the trained Actor network is capable of providing the optimal control strategy for the boundary control problem.
3: Verification of the effectiveness of the boundary control method proposed in this Invention.

### BRIEF DESCRIPTION OF DRAWINGS

FIG. 1: Traffic flow system model

FIG. 2: Block diagram of stabilizing the KdVB equation using the Soft Actor-Critic (SAC) reinforcement learning algorithm.

FIG. 3: Flowchart of the algorithm for stabilizing the KdVB equation using the SAC reinforcement learning algorithm.

FIG. 4: a=1, b=1, c=1 System state diagram.

### DETAILED DESCRIPTION OF THE INVENTION

### 1: Establishment of a Traffic Flow Control Problem Model Based on the Korteweg-De Vries-Burgers (KdVB) Equation.

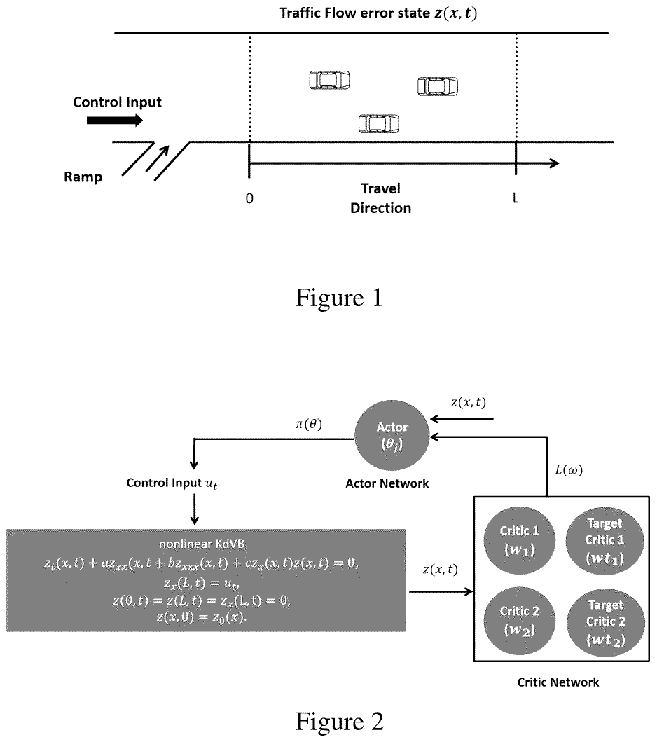

FIG. 1 illustrates a simplified traffic flow system, where vehicles travel from the entrance ramp at x=0 to the exit ramp at x=L. Let y(x, t) represent the traffic flow state in the traffic flow system, u₀ denote the desired traffic flow state, the objective is to stabilize the traffic flow state to the desired flow state u₀, and z(x, t)=y(x, t)−u₀ be the traffic flow error state, which represents the difference between the actual traffic flow state and the desired flow state, with t representing time.

The error system's model can be represented by the following KdVB equation:

$$\{ \begin{matrix}{z}_{t} ( x , t ) + {az}_{xx} ( x , t ) + {bz}_{xxx} ( x , t ) + cz ( x , t ) {z}_{x} ( x , t ) = 0 , \\ {z}_{x} ( 0 , t ) = U ( t ) , \\ z ( 0 , t ) = z ( L , t ) = {z}_{x} ( L , t ) = 0 , \\ z ( x , 0 ) = {z}_{0} ( x ) .\end{matrix}$$

Where x∈[0,L], t>0, with the ramp located at x=0 (entrance ramp) and at x=L (exit ramp), where adjustments are made to control the traffic flow. The boundary condition z(0, t)=z(L, t)=zₓ(L, t)=0, represent the velocity constraints at the entrance and exit.

The initial condition z(x, 0)=z₀(x) represents the error system state at time t=0. Here, a, b, and c are constant coefficients. The objective of the present invention is to stabilize the error system's state to zero, at which point the traffic flow state reaches the desired flow state u₀.

### 2: Design of a Control Method Based on a Reinforcement Learning Algorithm.

The present disclosure relates a reinforcement learning algorithm. The training objective of the reinforcement learning algorithm is to maximize the cumulative discounted reward of the policy. In this invention, the control input is chosen uₜ=U(t) given the system state sₜ, and the instantaneous reward function is defined by rₜ(sₜ, uₜ)=−∥sₜ−s*∥², where s* is the desired system state. Maximizing the cumulative discounted reward at this point corresponds to obtaining the maximum value of a non-positive function. After the neural network outputs the control signal, the cumulative discounted reward is fed back into the network. This process is repeated to train the neural network, maximizing the cumulative reward and obtaining the optimal policy. Finally, the optimal policy obtained is used for experimental verification.

In addition, the reinforcement learning KdVB boundary control method provided in this invention uses the SAC algorithm from reinforcement learning. This algorithm addresses the problem of overestimation in the action-value function by incorporating the DoubleDQN double Q-network idea, which enhances the stability of the algorithm.

The specific implementation steps are as follows:

Step 1. Transform the Traffic Flow Control Problem into a Markov Decision Process (MDP).

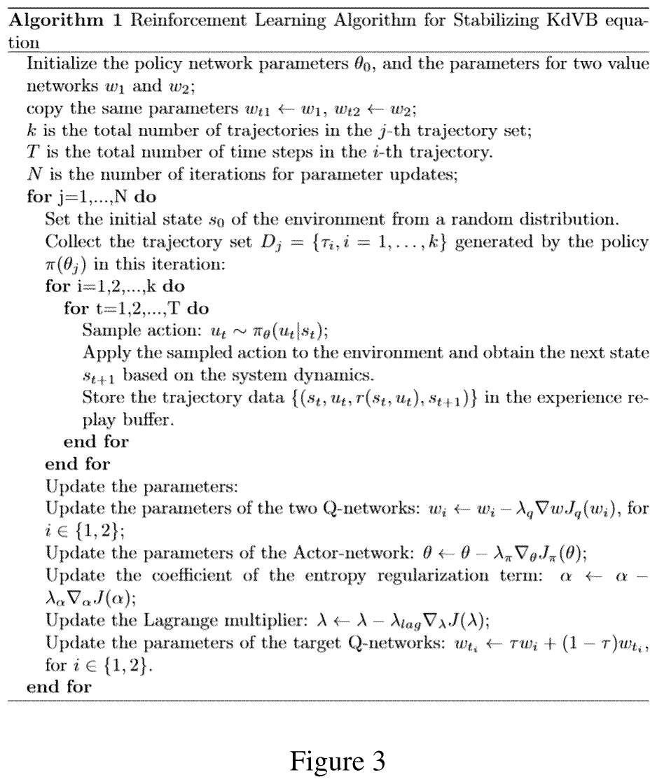

As shown in FIG. 3, the framework for designing a controller using reinforcement learning (RL) algorithms begins by transforming the traffic flow control problem into a Markov Decision Process (MDP). The key idea is to discretize the dynamics system and then express the problem in terms of states, actions, and rewards.

Define the spatial step size dx=L/(M−1) and the time step size dt=T/(N−1). Divide both the spatial and temporal domains into discrete intervals. This allows us to approximate the solution to the dynamics system as a piecewise constant function within each interval. The discretized system model can be expressed as follows: sₜ₊₁=f(sₜ, uₜ), where sₜ represents the system state vector at time t,

$${s}_{t} = {[ z ( 0 , t ) , z ( dx , t ) , … , z ( 1 , t ) ]}^{T} , t > 0 , {s}_{t} ∈ {ℝ}^{M} ,$$

uₜ represents the boundary control input at time t,

$${u}_{t} = U ( t ) = z ( 0 , t ) , t > 0 , {u}_{t} ∈ ℝ ,$$

the function f describes the system dynamics in a discrete form.

Therefore, the process of the system evolving over discrete time can be described as a Markov Decision Process (MDP).

$${s}_{t + 1} ∼ P ( {s}_{t + 1} \vert {s}_{t} , {u}_{t} ) ,$$

P(sₜ₊₁|sₜ, uₜ) p represents the transition probability of moving from state sₜ to state sₜ₊₁ under the action uₜ.

### Step 2: Establish a Simulation Environment for the Traffic Flow Control Problem Model to Collect Training Data.

Specifically, by discretizing the model from Step 1, the environment is established as a relationship between the state sₜ₊₁ at time t+1, the state sₜ₊₁ at time t, and the control input uₜ. The system state at each time step is continuously obtained as the controller interacts with the environment.

Here, we need to explain the settings of the parameters in the environment:

The main purpose of setting the model parameters is to construct a complete system dynamics model, which serves as a realistic environment simulator for algorithm training. This simulator is capable of simulating real-world scenarios, where only the measurement data of the system is available, but the model parameters are not directly known. In practical applications, these model parameters are often unknown. The method proposed in this work does not require reliance on these known model parameters for training the controller. This means that, even without knowledge of the system's internal mechanisms, effective controllers can still be trained using our approach.

The simulation step sizes can be set as dx=0.2, dt=0.0004, though these values can be adjusted based on practical needs. It is important to note that the simulation step size should not be too large, to avoid instability in the algorithm and a reduction in estimation accuracy.

Under the current policy π_{θ}_{ⱼ}, the controller interacts with the environment simulator to collect training trajectory data. The actions uₜ are generated from a normal distribution N(μ(sₜ), σ²(sₜ)), with the mean uₜ and standard deviation uₜ calculated by a deep neural network (DNN). After applying the action to the system environment, the next time step's state and immediate reward are obtained. When a round of interaction between the controller and the environment simulator ends, all the data pairs (sₜ, uₜ, sₜ₊₁, rₜ₊₁) corresponding to each time step of this round are stored in the buffer Dⱼ. The buffer will include k episodes of data.

### Step 3: Train the Actor-Critic Network

As shown in FIG. 2, the algorithm involves two neural networks: the Actor network (policy network) and the Critic network (value network).

The Actor network receives the state data from the environment simulator at a given time step and generates the corresponding control action. The Critic network estimates the value function, evaluating the current policy learned by the Actor network.

The Critic network consists of two primary Q-value function networks: Q-network1 (Q_{ω}_{₁}): Estimates the Q-value for the current state-action pair. Q-network2 (Q_{ω}_{₂}): Acts as an auxiliary network, providing an additional Q-value estimate. These two primary Q-value function networks are used to evaluate the Q-values for the current state-action pair, guiding the update of the policy network and stabilizing the Actor's training process.

Additionally, there are two target Q-value function networks: Target Q-network1 (Q_{ωt}_{₁}): Estimates the target Q-value for the next state. Target Q-network2 (Q_{ωt}_{₂}): Acts as an auxiliary network, providing an additional target Q-value estimate. These two target Q-value function networks are used to compute the double Q-learning targets in the SAC algorithm. When updating the primary Q-value function networks, the parameters of the primary Q-networks are gradually updated to the target Q-networks via soft update. This approach provides more stable and reliable target values.

By using these four Q-networks, the SAC algorithm reduces the estimation error of the target values and improves the algorithm's performance and convergence speed.

The objective function for updating the primary Q-value function networks in the Critic network is defined as:

$${J}_{critic} ( {ω}_{i} ) = {{E}_{t} [ \frac{1}{2} ( {Q}_{{ω}_{i}} ( {s}_{t} , {u}_{t} ) - ( R ( {s}_{t} , {u}_{t} ) + γ ( {min}_{j = 1 , 2} {Q}_{ω {t}_{j}} ( {s}_{t + 1} , {u}_{t + 1} ) - αlogπ ( \cdot \vert {s}_{t + 1} ) ) ]}^{2} ,$$

Where i∈{1,2}, ωᵢ is the parameter of the primary Q-value function network, Q_{ω}_{ᵢ} is a primary Q-value function network, R(sₜ, uₜ) represents the accumulated discounted reward, Q_{ωt}_{ⱼ} is the target Q-value function network, and π(⋅|sₜ₊₁) is the policy function, γ is discount factor, α is learning rate.

The Actor network iteratively updates its parameters based on the Critic network's estimation of the value function. The objective function for updating the Actor network parameters is defined as:

$${J}_{actor} ( θ ) = {E}_{t} [ αlog ( {π}_{θ} ( {f}_{θ} ( {ϵ}_{t} ; {s}_{t} ) \vert {s}_{t} ) ) - {min}_{i = 1 , 2} {Q}_{{ω}_{i}} ( {s}_{t} , {f}_{θ} ( {ϵ}_{t} ; {s}_{t} ) ) ] ,$$

Where Q_{ω}_{ᵢ} is a primary Q-value function network, and the policy function π_{θ}(f_{θ}(εₜ; sₜ)|sₜ), and θ is the parameter of the policy function, εₜ˜N(0,1), α is learning rate.

Once the parameters of the Actor-Critic network have been updated for a predetermined number of steps, the learned optimal policy becomes the optimal control strategy for the controller. This control strategy is then applied to the actual system, where it controls the system by influencing the behavior of the actuators. Based on the system's feedback, the controller's output is adjusted in real-time to adapt to changes in the system and to optimize control performance. For a detailed overview of the algorithm's flow, please refer to FIG. 3.

3: Verification of the Effectiveness of the Boundary Control Method Proposed in this Invention:

Let the initial condition be z₀(x)=sin((π(x))/L), and initialize the following parameters for the experimental setup: s(0)=[z(0, t), z(dx, t), . . . , z(L, t)]. The total simulation time is set to 20, with a steady-state value of s*=0. The controller interacts with the system environment for 200,000 steps, with every 400 steps considered as one sample, ensuring the convergence of the RL algorithm.

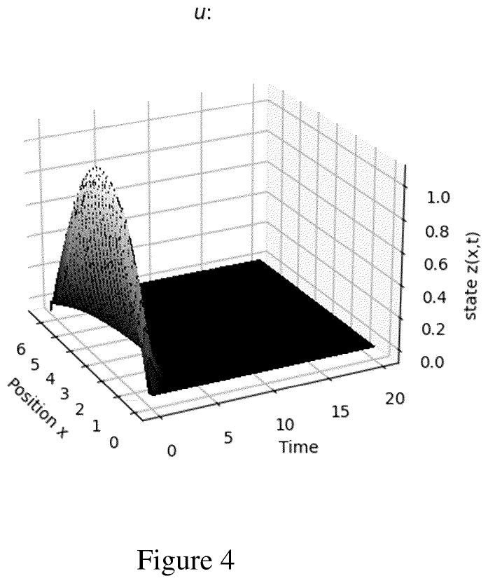

Experiments were conducted using the above data, and FIG. 4 illustrates the system state over time with parameters set to a=1, b=1, c=1. It can be observed that the proposed controller successfully stabilizes the system state to the steady-state value. This experimental example demonstrates that the controller designed based on the reinforcement learning approach effectively stabilizes the KdVB boundary control problem.

1. A control method for Traffic Flow System, comprising: establishing of a traffic flow control problem model; transforming the traffic flow control problem into a Markov decision process (MDP); establishing a simulation environment for the traffic flow control problem model; and stabilizing the traffic flow state using reinforcement learning algorithms, which includes: training an Actor-Critic network by interacting with the environment simulator; implementing the boundary control problem stabilization using the optimal controller output from the Actor network.

2. The control method of claim 1, wherein the traffic flow control problem model is established using the following KdVB equation:
$$\{ \begin{matrix}{z}_{t} ( x , t ) + {az}_{xx} ( x , t ) + {bz}_{xxx} ( x , t ) + cz ( x , t ) {z}_{x} ( x , t ) = 0 , \\ {z}_{x} ( 0 , t ) = U ( t ) , \\ z ( 0 , t ) = z ( L , t ) = {z}_{x} ( L , t ) = 0 , \\ z ( x , 0 ) = {z}_{0} ( x ) ,\end{matrix}$$
where z(x, t) is the error system state, which is the difference between the traffic flow and the desired flow, x∈[0,L], with the ramp located at x=0 (entry ramp), where adjustments are made to control the traffic flow; the boundary condition z(0, t)=z(L, t)=zₓ(L, t)=0, at x=L represents the outlet, which imposes constraints on vehicle flow; the initial condition z(x, 0)=z₀(x) represents the error system state at time t=0, and a, b, and c are constant coefficients.

3. The control method of claim 1, wherein the traffic flow control problem is discretized to a discretized system, and both the spatial step size dx=L/(M−1) and the time step size dt=T/(N−1) divide the spatial and temporal domains into discrete intervals, and the discretized system model can be expressed as follows: sₜ₊₁=f(sₜ, uₜ), where sₜ represents the system state vector at time t, sₜ=[z(0, t), z(dx, t), . . . , z(1, t)]^{T}, sₜ∈ [symbol] , the boundary control input uₜ=U(t)=z(0, t), uₜ∈ [symbol] , and the function f describes the system dynamics in a discrete form.

4. The control method of claim 3, wherein discretized system is established as a relationship between the state sₜ₊₁ at time t+1, the state sₜ₊₁ at time t, and the control input uₜ, and the discretized system is described as a Markov Decision Process (MDP) sₜ₊₁˜P(sₜ₊₁|sₜ, uₜ), where P(sₜ₊₁|sₜ, uₜ) p represents the transition probability of moving from state sₜ to state sₜ₊₁ under the action uₜ.

5. The control method of claim 1, wherein the simulation environment is established using the current policy to interact the controller with the environment simulator, and collect training data, including applying actions to the model through an actuator and observing the system's state and reward signals.

6. The control method of claim 1, wherein the Actor-Critic network is trained through the following steps: using the Critic network to approximate the value function and evaluate the current policy to assess its quality, and updating the Critic network's parameters to improve the value function approximation; based on the value function, updating the Actor network's parameters to refine and optimize the policy; the controller, under the updated policy, again interacts with the system environment to collect new data; repeating the network parameter updates until a predetermined number of updates is reached.

7. The control method of claim 1, wherein the reinforcement learning algorithm is Soft Actor-Critic (SAC) algorithm, the neural networks used in the algorithm include Actor network and Critic network, and the instantaneous reward function used in the algorithm is a negative L² norm, defined as rₜ(sₜ, uₜ)=−∥sₜ−s*∥², where s* represents the expected system state.

8. The control method to claim 7, wherein the Critic network is configured to use a gradient descent method to minimize a difference between an estimated value function and a cumulative discounted reward, and wherein the objective function for updating a primary Q-value function network of the Critic network is defined as:
$${J}_{critic} ( {ω}_{i} ) = {{E}_{t} [ \frac{1}{2} ( {Q}_{{ω}_{i}} ( {s}_{t} , {u}_{t} ) - ( R ( {s}_{t} , {u}_{t} ) + γ ( {min}_{j = 1 , 2} {Q}_{ω {t}_{j}} ( {s}_{t + 1} , {u}_{t + 1} ) - αlogπ ( \cdot \vert {s}_{t + 1} ) ) ) ]}^{2} ,$$
Where i∈{1,2}, ωᵢ is the parameter of the primary Q-value function network; Q_{ω}_{ᵢ} is a primary Q-value function network; R(sₜ, uₜ) represents the accumulated discounted reward; Q_{ωt}_{ⱼ} is the target Q-value function network; and π(⋅|sₜ₊₁) is the policy function, γ is discount factor, α is learning rate.

9. The control method to claim 7, wherein the Actor network is configured to use a gradient ascent algorithm to maximize a policy gradient, and wherein the objective function for updating the parameters of the Actor network is defined as:
$${J}_{actor} ( θ ) = {E}_{t} [ αlog ( {π}_{θ} ( {f}_{θ} ( {ϵ}_{t} ; {s}_{t} ) \vert {s}_{t} ) ) - {min}_{i = 1 , 2} {Q}_{{ω}_{i}} ( {s}_{t} , {f}_{θ} ( {ϵ}_{t} ; {s}_{t} ) ) ] ,$$
Where θ is the parameter of the policy function; Q_{ω}_{ᵢ} is a primary Q-value function network; and the policy function π_{θ}(f_{θ}(∈ₜ; sₜ)|sₜ); ∈ₜN(0,1); α is learning rate.
